(19) United States
(12) Patent Application Publication
(10) Pub. No.: US 2009/0073103 A1
(43) Pub. Date: Mar. 19, 2009

(54) LIQUID CRYSTAL DISPLAY DEVICE AND DRIVING METHOD THEREOF

(75) Inventor: Kenichi TAJIRI, Ichinomiya-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, Azumino-shi (JP)

(21) Appl. No.: 12/208,863

(22) Filed: Sep. 11, 2008

(30) Foreign Application Priority Data
Sep. 14, 2007 (JP) 2007-238818
Sep. 19, 2007 (JP) 2007-242363

(51) Int. Cl. G09G 3/36

(52) U.S. Cl. 345/98

(57) ABSTRACT

A liquid crystal display device includes: a pixel region including a plurality of pixels; a plurality of storage capacitance lines; a storage capacitor connected between a pixel electrode of each of the pixels and each of the storage capacitance lines; a polarity signal generating circuit that generates a polarity signal, which is repeatedly inverted between a first level and a second level for every frame, in a display region of the pixel region where an image is displayed and that fixes the polarity signal to the first level or the second level in a non-display region where an image is not displayed; a first switching element that switches an electric potential of the storage capacitance line according to the polarity signal generated by the polarity signal generating circuit; and a control circuit that when the display region is changed to the non-display region, makes a control such that a refresh operation of writing a signal corresponding to non-display into the pixel electrode of the pixel corresponding to the non-display region is intermittently performed in some frames and the refresh operation is performed in two or more continuous frames.

### BACKGROUND

1. Technical Field

The present invention relates to a storage capacitance line driving type liquid crystal display device and a driving method thereof.

2. Related Art

A storage capacitance line driving method is known as a driving method of a liquid crystal display device in the related art. In this method, a storage capacitor is provided between a storage capacitance line and a pixel electrode, and the electric potential of the pixel electrode is changed in a positive or negative direction by writing a display signal into the pixel electrode and then changing the electric potential of the storage capacitance line. Thus, since a dynamic range of the display signal can be made small, driving becomes possible with low power consumption. A liquid crystal display device using the storage capacitance line driving method is disclosed in JP-A-2002-196358.

In addition, a partial display method is known as a display method of a liquid crystal display device. In this method, a part of a pixel region is set as a display region where an image is displayed and the remaining region is set as a non-display region (white or black display region) where an image is not displayed.

In the case of performing partial display in the liquid crystal display device that uses the storage capacitance line driving method, the power consumption can be reduced by stopping driving of a storage capacitance line in a non-display region. This type of liquid crystal display device is disclosed in JP-A-2007-140192.

However, in the case of stopping a polarity signal for determining the priority of the electric potential of the storage capacitance line while maintaining the priority before one frame when stopping driving of the storage capacitance line, the operation becomes complicated if a display region is changed. As a result, a problem that the circuit configuration becomes complicated occurs. Therefore, in order to simplify the circuit configuration, a method of fixing a polarity signal to an L level or an H level may be considered in the non-display region. In the non-display region, it is required to perform a refresh operation for periodically writing a non-display signal into a pixel electrode of a corresponding pixel. In this case, in order to further reduce the power consumption, the refresh operation is not performed in all frames but is intermittently performed in some frames, that is, intermittent refresh (also referred to as thinning-out refresh) is performed. However, in the case where a polarity signal is fixed to an L level or an H level in the non-display region, there has been a problem that poor display occurs when the above intermittent refresh is performed.

Moreover, in order to reduce the power consumption resulting from the refresh operation, the intermittent refresh (also referred to as thinning-out refresh) in which the refresh operation is not performed in all frames but is intermittently performed in some frames is performed. In the case of performing the intermittent refresh, however, there has been a problem that poor display occurs in the non-display region. This is because when the intermittent refresh is performed, the polarity of a polarity signal for determining the polarity of a storage capacitance line is not inverted in the non-display region, unlike a display region, depending on selection of a frame in which the refresh operation is performed.

### SUMMARY

According to an aspect of the invention, a liquid crystal display device includes: a pixel region including a plurality of pixels; a plurality of storage capacitance lines; a storage capacitor connected between a pixel electrode of each of the pixels and each of the storage capacitance lines; a polarity signal generating circuit that generates a polarity signal, which is repeatedly inverted between a first level and a second level for every frame, in a display region of the pixel region where an image is displayed and that fixes the polarity signal to the first level or the second level in a non-display region where an image is not displayed; a first switching element that switches an electric potential of the storage capacitance line according to the polarity signal generated by the polarity signal generating circuit; and a control circuit that when the display region is changed to the non-display region, makes a control such that a refresh operation of writing a signal corresponding to non-display into the pixel electrode of the pixel corresponding to the non-display region is performed in two or more continuous frames and the refresh operation is stopped performed in subsequent frames.

Furthermore, according to another aspect of the invention, a driving method of a liquid crystal display device that includes a pixel region including a plurality of pixels, a plurality of storage capacitance lines, a storage capacitor connected between a pixel electrode of each of the pixels and each of the storage capacitance lines, a polarity signal generating circuit that generates a polarity signal, which is repeatedly inverted between a first level and a second level for every frame, in a display region of the pixel region where an image is displayed and that fixes the polarity signal to the first level or the second level in a non-display region where an image is not displayed, and a first switching element that switches an electric potential of the storage capacitance line according to the polarity signal generated by the polarity signal generating circuit includes intermittently performing a refresh operation of writing a signal corresponding to non-display into the pixel electrode of the pixel corresponding to the non-display region in some frames and performing the refresh operation in two or more continuous frames when the display region is changed to the non-display region.

Furthermore, according to still another aspect of the invention, a liquid crystal display device includes: a pixel region including a plurality of pixels; a plurality of source lines; a plurality of gate lines; a plurality of storage capacitance lines; a storage capacitor connected between a pixel electrode of each of the pixels and each of the storage capacitance lines; a gate selection circuit that outputs a gate selection signal to the gate lines; a first latch circuit that latches a polarity signal, which repeats inversion alternately between a first level and a second level for every frame, according to the gate selection signal; a first switching element that switches an electric potential of the storage capacitance line according to an output signal of the first latch circuit; and a second switching element that is provided for every pixel, switches according to the gate selection signal, and supplies a source signal from the source line to the pixel electrode. In a non-display region of the pixel region where an image is not displayed, a control is made such that a refresh operation of supplying a source signal corresponding to non-display to the corresponding pixel through the first switching element is performed in remaining frames after thinning out two or more frames and a polarity signal is inverted in a first frame in which a refresh operation is performed and a second frame in which a next refresh operation is performed.

Furthermore, according to still another aspect of the invention, a driving method of a liquid crystal display device that includes a pixel region including a plurality of pixels, a plurality of source lines, a plurality of gate lines, a plurality of storage capacitance lines, a storage capacitor connected between a pixel electrode of each of the pixels and each of the storage capacitance lines, a gate selection circuit that outputs a gate selection signal to the gate lines, a first latch circuit that latches a polarity signal, which repeats inversion alternately between a first level and a second level for every frame, according to the gate selection signal, a first switching element that switches an electric potential of the storage capacitance line according to an output signal of the first latch circuit, and a second switching element that is provided for every pixel, switches according to the gate selection signal, and supplies a source signal from the source line to the pixel electrode includes: making a control such that in a non-display region of the pixel region where an image is not displayed, a refresh operation of supplying a source signal corresponding to non-display to the corresponding pixel through the first switching element is performed in remaining frames after thinning out two or more frames and a polarity signal is inverted in a first frame in which a refresh operation is performed and a second frame in which a next refresh operation is performed.

According to the aspect of the invention, in the storage capacitance line driving type liquid crystal display device, power consumption at the time of partial display can be reduced with the simple circuit configuration. In addition, it is possible to prevent poor display from occurring in the case of intermittently performing a refresh operation in a non-display region.

In addition, in the case of performing intermittent refresh in order to reduce the power consumption at the time of the partial display, the poor display can be prevented since the polarity of a polarity signal can also be inverted in the non-display region in the same manner as in the display region.

### BRIEF DESCRIPTION OF THE DRAWINGS

The invention will be described with reference to the accompanying drawings, wherein like numbers reference like elements.

FIG. 1 is a view illustrating the configuration of a liquid crystal display device according to a first embodiment of the invention.

FIG. 2 is a view illustrating the configurations of storage capacitance line driving circuit and polarity signal generating circuit in the liquid crystal display device according to the first embodiment of the invention.

FIG. 3 is a view illustrating the configurations of source line driving circuit and DSG control circuit in the liquid crystal display device according to the first embodiment of the invention.

FIG. 4 is a timing chart explaining an operation of the liquid crystal display device according to the first embodiment of the invention and a comparative example.

FIG. 5 is a timing chart explaining an operation of the liquid crystal display device in a comparative example.

FIG. 6 is a timing chart explaining an operation of the liquid crystal display device according to the first embodiment of the invention.

FIG. 7 is a timing chart explaining an operation of the liquid crystal display device according to the first embodiment of the invention.

FIG. 8 is a view illustrating the configuration of a liquid crystal display device according to a second embodiment of the invention.

FIG. 9 is a view illustrating the configuration of a storage capacitance line driving circuit in the liquid crystal display device according to the second embodiment of the invention.

FIG. 10 is a view illustrating the configuration of a storage capacitance line driving circuit in the liquid crystal display device according to the second embodiment of the invention.

FIG. 11 is a timing chart illustrating an operation of the storage capacitance line driving circuit in the liquid crystal display device according to the second embodiment of the invention,

FIG. 12 is a view illustrating the configurations of source line driving circuit and DSG control circuit in the liquid crystal display device according to the second embodiment of the invention.

FIG. 13 is a timing chart explaining an operation of the liquid crystal display device according to the second embodiment of the invention.

FIGS. 14A and 14B are timing charts explaining an operation of the liquid crystal display device according to the second embodiment of the invention and a comparative example.

### DESCRIPTION OF EXEMPLARY EMBODIMENTS

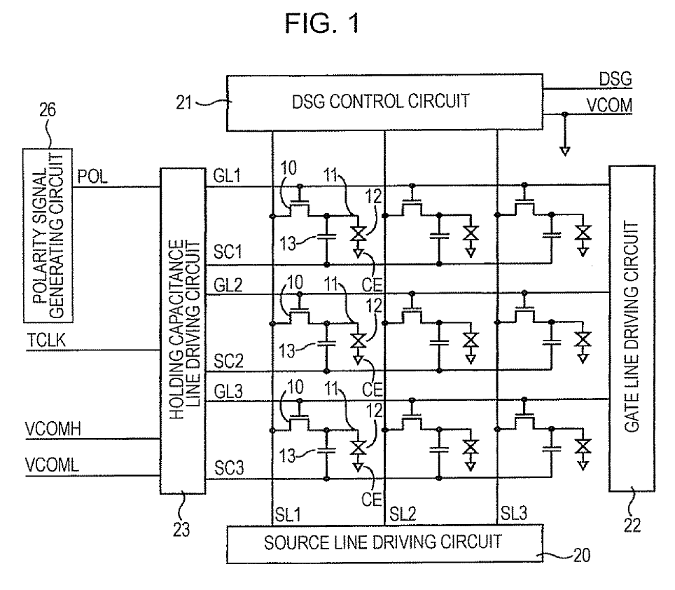

Hereinafter, a liquid crystal display device according to a first embodiment of the invention will be described with reference to the accompanying drawings. FIG. 1 is a block diagram illustrating a liquid crystal display device. This liquid crystal display device uses a storage capacitance line driving method and is able to perform partial display.

A plurality of pixels are arrayed in a matrix to form a pixel region. In FIG. 1, nine pixels of three rows by three columns are shown for the simplicity sake. Each pixel is disposed corresponding to each of intersections of gate lines GL1 to GL3 and source lines SL1 to SL3. In addition, a pixel transistor 10 formed of an N-channel thin film transistor, a pixel electrode 11 connected to a drain of the pixel transistor 10, and liquid crystal 12 disposed between the pixel electrode 11 and a common electrode CE are provided in each pixel. A common electric potential VCON is supplied to the common electrode CE.

In addition, a first storage capacitance line SC1 is provided corresponding to pixels on a first line, and a storage capacitor 13 is provided between the pixel electrode 11 and the first storage capacitance line SC1. A second storage capacitance line SC2 is provided corresponding to pixels on a second row, and the storage capacitor 13 is provided between the pixel electrode 11 and the second storage capacitance line SC2. A third storage capacitance line SC3 is provided corresponding to pixels on a third line, and the storage capacitor 13 is provided between the pixel electrode 11 and the third storage capacitance line SC3.

In addition, a source of the pixel transistor 10 of each pixel on a first column is connected to the first source line SL1, a source of the pixel transistor 10 of each pixel on a second column is connected to the second source line SL2, and a source of the pixel transistor 10 of each pixel on a third column is connected to the third source line SL3.

In addition, a gate of the pixel transistor 10 of each pixel on the first row is connected to the first gate line GL1, a gate of the pixel transistor 10 of each pixel on the second row is connected to the second gate line GL2, and a gate of the pixel transistor 10 of each pixel on the third row is connected to the third gate line GL3.

In addition, a source line driving circuit 20 that supplies a source signal Sig (display signal) to the first to third source lines SL1 to SL3 is provided. The source signal Sig has a polarity that is inverted with respect to a reference potential at predetermined periods (for example, one horizontal period). In addition, a DSG control circuit 21 that supplies the common electric potential VCOM to the first to third source lines SL1 to SL3 is provided corresponding to a control signal DSG.

In addition, a gate line driving circuit 22 that supplies a gate signal to the first to third gate lines GL1 to GL3 is provided. In addition, a storage capacitance line driving circuit 23 that drives the first to third storage capacitance lines SC1 to SC3 is provided. In addition, a polarity signal generating circuit 26 that generates a polarity signal POL for determining the polarity of each electric potential of the first to third storage capacitance lines SC1 to SC3 is provided. The storage capacitance line driving circuit 23 drives each of the electric potentials of the first to third storage capacitance lines SC1 to SC3 to be a low electric potential VCOML or a high electric potential VCOMH on the basis of the polarity signal POL output from the polarity signal generating circuit 26.

### Configurations of Storage Capacitance Line Driving Circuit and Polarity Signal Generating Circuit

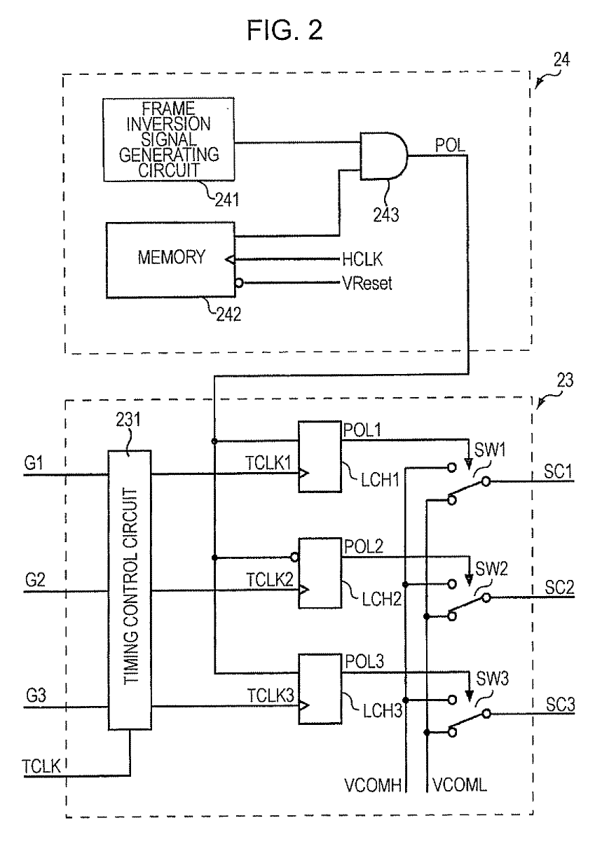

FIG. 2 is a view illustrating the configuration of the storage capacitance line driving circuit 23 and the configuration of the polarity signal generating circuit 26. First, the configuration of the polarity signal generating circuit 26 will be described. The polarity signal generating circuit 26 is formed by using a frame inversion signal generating circuit 241 and a memory 242. The frame inversion signal generating circuit 241 is a circuit that generates a frame inversion signal, which is repeatedly inverted between an H level and an L level for every frame. In the memory 242, data indicating distinction between a display region of a pixel region, in which an image is displayed, and a non-display region where an image is not displayed is stored corresponding to each line (each row), The data is ‘1’ in the display region and ‘0’ in the non-display region. The memory 242 may be formed by using a shift register, for example. The memory 242 performs operations of holding and shifting data in synchronization with a clock HCLK which is a pulse signal having a period of one horizontal period (1H period).

The frame inversion signal generated by the frame inversion signal generating circuit 241 and the data read from the memory 242 in synchronization with the clock HCLK are input to a two-input AND circuit 243. The AND circuit 243 outputs the frame inversion signal as the polarity signal POL when the data read from the memory 242 indicates a display region, that is, when the data is ‘1’. In addition, an output of the AND circuit 243 is fixed to ‘0’ when the data read from the memory 242 indicates a non-display region, that is, when the data is ‘1’. That is, the AND circuit 243 outputs the polarity signal POL fixed to ‘0’ (=L level) in this case.

Thus, in the display region, the polarity signal POL is inverted for every frame. In addition, when full screen display in which an image is displayed in the entire pixel region transitions to partial display (or when a display region is changed in the partial display), it is possible to fix the polarity of the polarity signal POL in the non-display region. In addition, since the polarity signal generating circuit 26 can be configured to include only the frame inversion signal generating circuit 241 (may be formed by an inverting circuit), the memory 242, and the AND circuit 243, the circuit configuration becomes simple.

A Vreset signal is a signal synchronizing with a vertical synchronizing signal and serves to reset a read counter of a first memory and a second memory.

Next, the configuration of the storage capacitance line driving circuit 23 will be described. The polarity signal POL output from the polarity signal generating circuit 26 is latched to latch circuits LCH1 to LCH3 provided corresponding to the first to third storage capacitance lines SC1 to SC3, respectively, on the basis of first to third timing clocks TCLK1 to TCLK3. The latch circuits LCH1 to LCH3 output the latched polarity signal POL as first to third latch signals POL1 to POL3 and hold the latched polarity signal POL. The first to third timing clocks TCLK1 to TCLK3 are generated on the basis of gate signals G1 to G3 and a timing control signal TCLK by a timing control circuit 231.

In addition, the polarity signal POL that is inverted is latched to the latch circuit LCH2 corresponding to an even-numbered line. This is to make line inversion possible by causing the electric potentials of the storage capacitance lines corresponding to odd-numbered lines (first line, third line, . . . ) and even-numbered lines (second line, fourth line, . . . ) to have opposite polarities. For example, the electric potential of the first storage capacitance line SC1 and the electric potential of the second storage capacitance line SC2 have opposite polarities.

The first to third latch signals POL1 to POL3 are used as signals for controlling switching of first to third switches SW1 to SW3 provided in a subsequent stage. For example, the low electric potential VCOML is applied to the first storage capacitance line SC1 when the first latch signal POL1 is in an H level, and the high electric potential VCOMH is applied to the first storage capacitance line SC1 when the first latch signal POL1 is in an L level.

That is, the electric potentials of the first to third storage capacitance lines SC1 to SC3 are determined by timing at which the first to third timing clocks TCLK1 to TCLK3 rise. In such a storage capacitance line driving method, it is general that such timing occurs after the gate signals G1 to G3 fall.

### Configurations of Source Line Driving Circuit and DSG Control Circuit

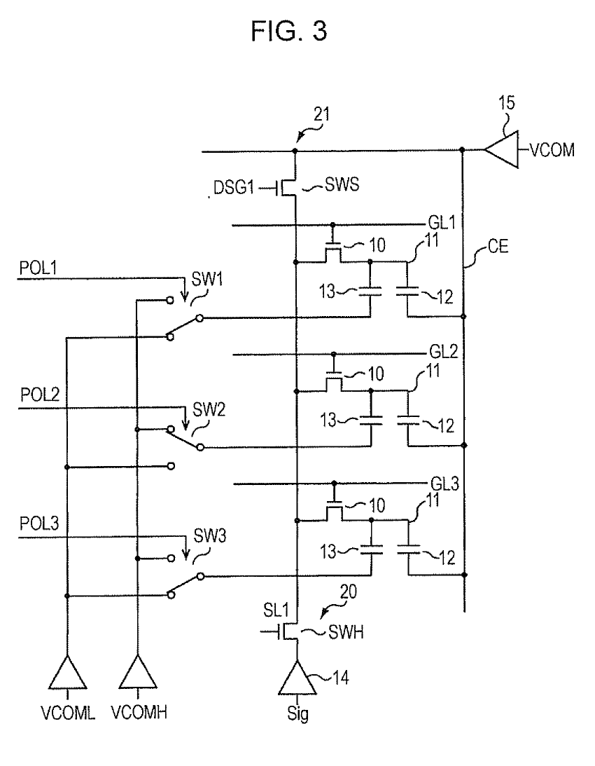

FIG. 3 is a view illustrating the configurations of the source line driving circuit 20 and DSG control circuit 21 which are provided in the periphery of the pixel region. In FIG. 3, only the configuration related to pixels corresponding to the first column of the pixel region is shown. An output terminal of a source driver 14 is connected to one end of the first source line SL1 with a horizontal switch SWH interposed therebetween. The horizontal switch SWH switches according to a horizontal scanning signal. When the horizontal switch SWH is turned on, the source signal Sig (display signal) is supplied from the source driver 14 to the first source line SL1. In addition, an output terminal of a common electrode driver 15 is connected to the other end of the first source line SL1 with a switch SWS interposed therebetween. The switch SWS switches according to the DSG signal. In addition, the output terminal of the common electrode driver 15 is connected to the common electrode CE, and the common electric potential VCOM is supplied to the common electrode CE.

Accordingly, when the switch SWS is turned on, the first source line SL1 and the common electrode CE are short circuited, such that the common electric potential VCOM is also supplied to the first source line SL1.

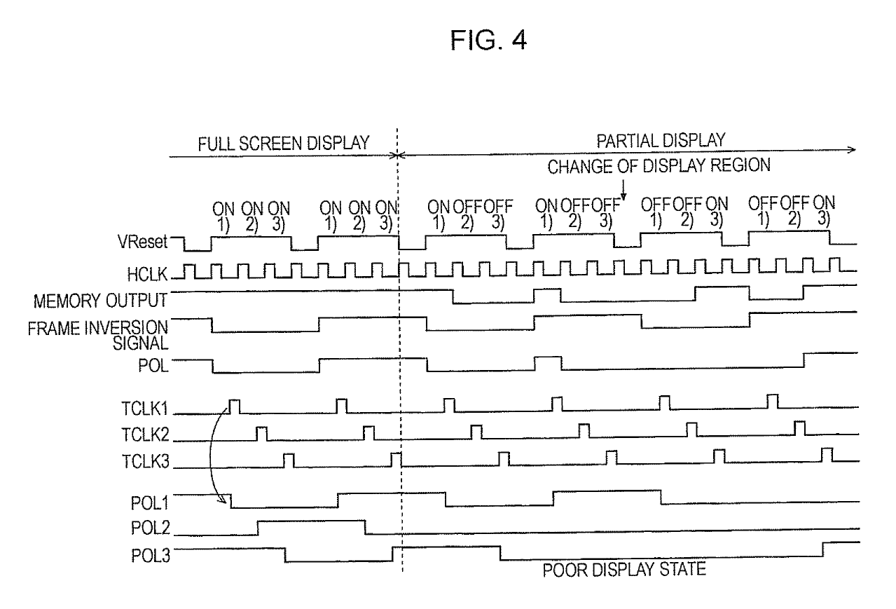

Next, an operation example of the liquid crystal display device will be described with reference to a timing chart shown in FIG. 4. This explanation is based on the circuit shown in FIG. 1, and the number of lines is set to 3. 1), 2), and 3) in the drawing indicate line numbers, ‘ON’ indicates a display region, and ‘OFF’ indicates a non-display region. Full screen display is performed at first. Since data=‘1’ is stored in the memory 242 corresponding to the first to third lines, an output of the memory 242 is maintained as ‘1’. Accordingly, the polarity signal POL is repeatedly inverted between a first level and a second level for every frame.

In addition, the polarity signal POL is sequentially latched to the latch circuits LCH1 to LCH3 on the basis of the first to third timing clocks TCLK1 to TCLK3 generated in a time-series manner, and thus the first to third latch signals POL1 to POL3 that repeat inversion for every frame are generated. Accordingly, the electric potentials of the first to third storage capacitance lines SC1 to SC3 are repeatedly inverted in synchronization with the first to third latch signals POL1 to POL3. As a result, storage capacitance line driving is performed. That is, a display signal is written into the pixel electrode and then the electric potential of the corresponding storage capacitance line is changed and accordingly, the electric potential of the pixel electrode 11 is changed in a positive or negative direction. Thus, since a dynamic range of the display signal can be made small, driving becomes possible with low power consumption.

Then, transition from the full screen display to partial display is performed. Here, it is assumed that the content of the memory 242 has been changed such that the first line corresponds to a display region and the second and third lines correspond to a non-display region. Then, for the first line, the polarity signal POL is repeatedly inverted between an H level and an L level. Since the second and third lines correspond to the non-display region, the polarity signal POL is fixed to the L level. As a result, driving of the second and third storage capacitance lines SC2 and SC3 is stopped.

Furthermore, in the non-display region, pixels are not displayed by writing the common electric potential VCOM (non-display signal) into pixel electrodes of the corresponding pixels. This will be described with reference to FIG. 3. In the non-display region, the switch SWS is turned on according to the DSG signal, the first source line SL1 and the common electrode CE are short circuited, and the common electric potential VCOM is also supplied to the first source line SL1. Then, when the pixel transistor 10 is turned on according to the gate signal G1, the common electric potential VCOM is applied to the pixel electrode 11. As a result, since a voltage applied to the liquid crystal 12 becomes about 0 V, a non-display state (for example, black display in a normally black liquid crystal display device) is acquired.

Thus, in the non-display region, a refresh operation of periodically writing a non-display signal into a pixel electrode of the corresponding pixel is performed. In addition, in order to reduce the power consumption, intermittent refresh in which the refresh operation is not performed for all frames but is intermittently performed only for some frames is performed.

However, as shown in FIG. 4, the third latch signal POL3 changes from an H level to an L level on the third line after transition to partial display. Accordingly, since the storage capacitance line driving is performed, the third storage capacitance line SC3 is changed after the common electric potential VCOM (non-display signal) is written into the pixel electrode. As a result, since a voltage applied to the liquid crystal 12 changes from 0 V, poor display occurs when the intermittent refresh is performed.

Subsequently, a display region is changed in the partial display. Here, it is assumed that the content of the memory 242 has been changed such that the first and second lines correspond to a non-display region and the third line corresponds to a display region. Then, since the first and second lines correspond to the non-display region, the polarity signal POL is fixed to the L level. That is, driving of the first and second storage capacitance lines SC1 and SC2 is stopped. On the other hand, since a changed to the display region has been made for the third line, the polarity signal POL is inverted.

As described above, in the case of performing the partial display, the power consumption may be reduced by fixing the polarity of the polarity signal POL to stop driving of a storage capacitance line in the non-display region. However, the poor display occurs when the above-described intermittent refresh is performed.

Therefore, in the invention, when the full screen display transitions to the partial display, a refresh operation of writing the common electric potential VCOM (non-display signal) into a pixel corresponding to the non-display region is performed in two or more continuous frames on the assumption of the intermittent refresh. As a result, poor display can be prevented by eliminating display failure in a first frame.

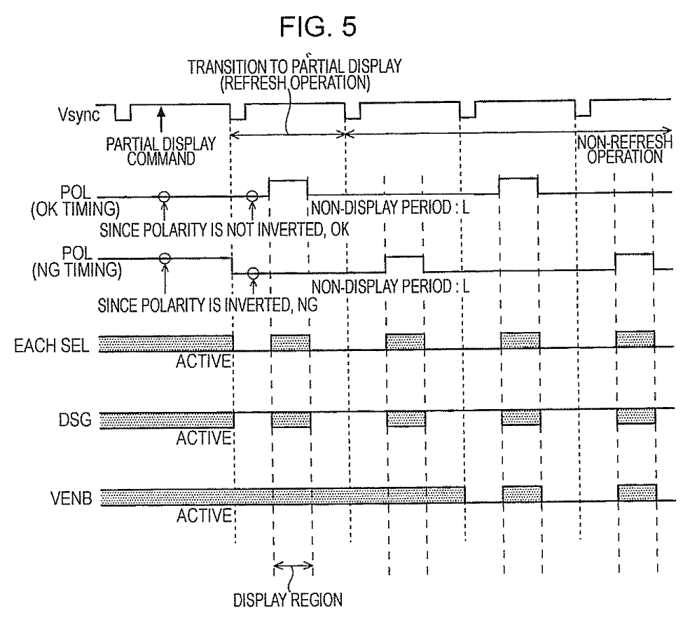

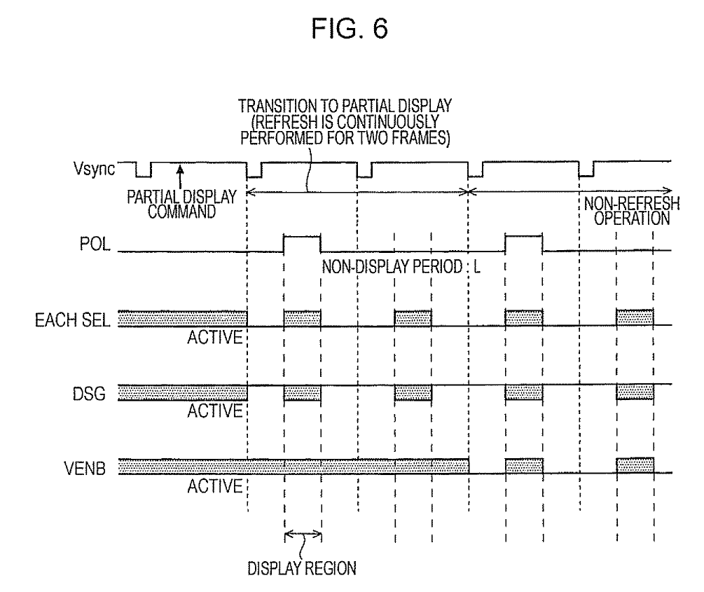

This will be described in more detail using timing charts shown in FIGS. 5 and 6. As shown in FIG. 5, it is assumed that when full screen display transitions to partial display in response to a partial display command, a refresh operation is performed in one frame after the transition and then some frames in which the refresh operation is not performed, that is, some non-refresh frames continue. That is, the intermittent refresh is performed.

Then, when the polarity signal POL is not inverted (L level is maintained in the case of FIG. 5), the above-described poor display does not occur. However, when the polarity signal POL is inverted (changes from an H level to an L level in the case of FIG. 5), the poor display occurs for the above-described reason.

Then, as shown in FIG. 6, when the full screen display transitions to the partial display from on the basis of a partial display command, a refresh operation is performed in two continuous frames after the transition. Then, some non-refresh frames continue. As a result, poor display can be prevented by eliminating display failure in a first frame after the transition to the partial display by means of a refresh operation in a next frame.

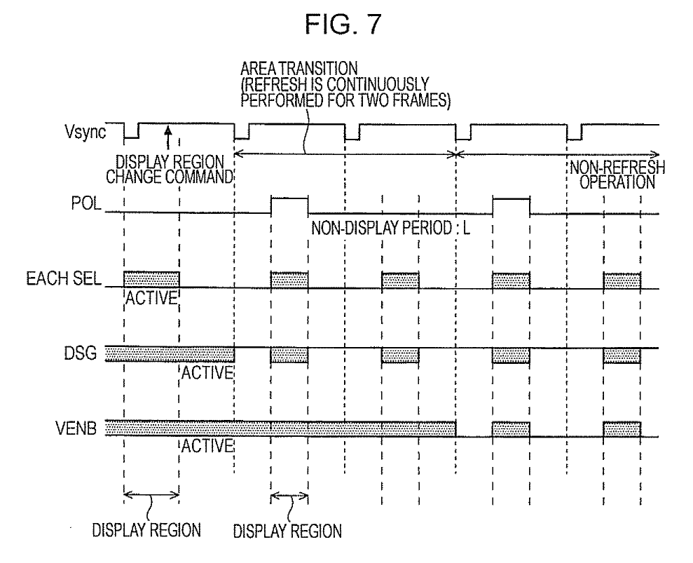

In addition, the same is true for a case where a display region is changed in the partial display on the basis of the display region change command, which is shown in FIG. 7. That is, a refresh operation is performed in two continuous frames after changing a display region in the partial display. Then, some non-refresh frames continue. As a result, poor display can be prevented by eliminating display failure in a first frame after changing a display region by means of a refresh operation in a next frame.

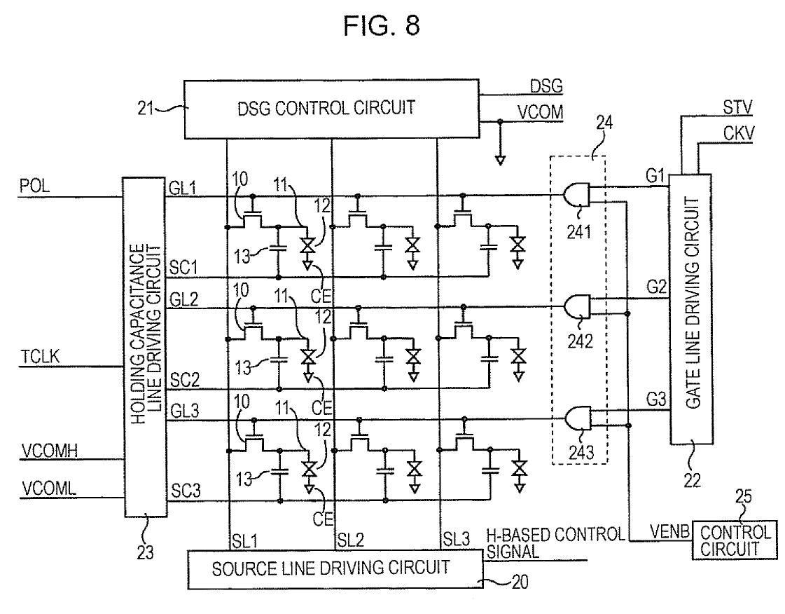

A liquid crystal display device according to a second embodiment of the invention will be described with reference to the accompanying drawings. FIG. 8 is a block diagram illustrating a liquid crystal display device. This liquid crystal display device uses a storage capacitance line driving method and is able to perform partial display.

A plurality of pixels are arrayed in a matrix to form a pixel region. In FIG. 8, nine pixels of three rows by three columns are shown for the simplicity sake. Each pixel is disposed corresponding to each of intersections of gate lines GL1 to GL3 and source lines SL1 to SL3. In addition, a pixel transistor 10 formed of an N-channel thin film transistor, a pixel electrode 11 connected to a drain of the pixel transistor 10, and liquid crystal 12 disposed between the pixel electrode 11 and a common electrode CE are provided in each pixel. A common electric potential VCOM is supplied to the common electrode CE.

In addition, a first storage capacitance line SC1 is provided corresponding to pixels on a first line, and a storage capacitor 13 is provided between the pixel electrode 11 and the first storage capacitance line SC1. A second storage capacitance line SC2 is provided corresponding to pixels on a second row, and the storage capacitor 13 is provided between the pixel electrode 11 and the second storage capacitance line SC2. A third storage capacitance line SC3 is provided corresponding to pixels on a third line, and the storage capacitor 13 is provided between the pixel electrode 11 and the third storage capacitance line SC3.

In addition, a source of the pixel transistor 10 of each pixel on a first column is connected to the first source line SL1, a source of the pixel transistor 10 of each pixel on a second column is connected to the second source line SL2, and a source of the pixel transistor 10 of each pixel on a third column is connected to the third source line SL3.

In addition, a gate of the pixel transistor 10 of each pixel on the first row is connected to the first gate line GL1, a gate of the pixel transistor 10 of each pixel on the second row is connected to the second gate line GL2, and a gate of the pixel transistor 10 of each pixel on the third row is connected to the third gate line GL3.

In addition, a source line driving circuit 20 that supplies a source signal Sig (display signal) to the first to third source lines SL1 to SL3 is provided. The source signal Sig has a polarity that is inverted with respect to a reference potential at predetermined periods (for example, one horizontal period). In addition, a DSG control circuit 21 that supplies the common electric potential VCOM to the first to third source lines SL1 to SL3 is provided corresponding to a control signal DSG.

In addition, a gate line driving circuit 22 that generates gate selection signals G1 to G3 is provided. The gate selection signals G1 to G3 are generated by transmitting a vertical start pulse STV on the basis of a vertical shift pulse CKV. In addition, a gate selection circuit 24 that outputs the gate selection signals G1 to G3 to the first to third gate lines GL1 to GL3 on the basis of a gate selection enable signal VENB is provided. That is, the gate selection circuit 24 is formed by using AND circuits 241 to 243, the gate selection signals G1 to G3 are input to the corresponding AND circuits 241 to 243, and the gate selection enable signal VENB is commonly input to the AND circuits 241 to 243. Accordingly, the gate selection signals G1 to G3 are output to the first to third gate lines GL1 to GL3 when the gate selection enable signal VENB is in an H level. When the gate selection enable signal VENB is in an L level, an output of the gate selection circuit 24 is fixed to the L level. Accordingly, the gate selection signals G1 to G3 become in a non-selection state (the pixel transistor 10 is in an OFF state). The gate selection enable signal VENB is controlled by a control circuit 25.

In addition, a storage capacitance line driving circuit 23 that drives the first to third storage capacitance lines SC1 to SC3 is provided. The storage capacitance line driving circuit 23 drives each of the electric potentials of the first to third storage capacitance lines SC1 to SC3 to be a low electric potential VCOML or a high electric potential VCOMH on the basis of the polarity signal POL inverted between an H level and an L level for every frame.

### Configuration of a Storage Capacitance Line Driving Circuit

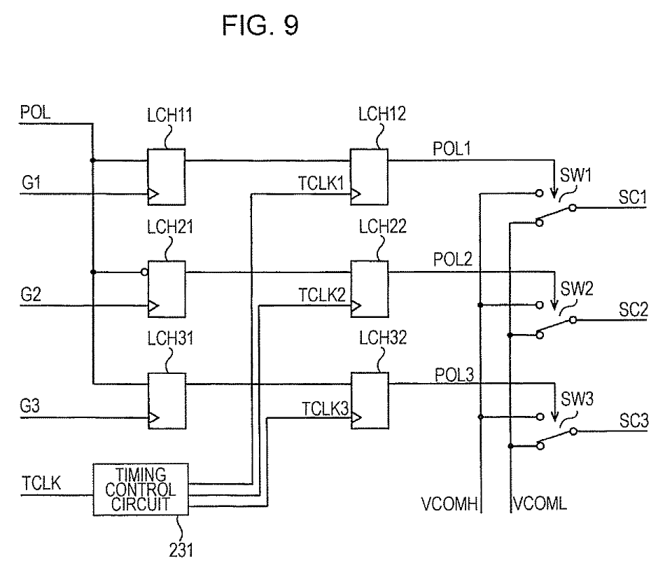

The configuration of the storage capacitance line driving circuit 23 is shown in FIG. 9. This circuit is called a gate latch type circuit and latches the polarity signal POL on the basis of the gate selection signals G1 to G3. First latch circuits LCH11, LCH21, and LCH31 are provided corresponding to the first to third storage capacitance lines SC1 to SC3, respectively. The first latch circuits LCH11, LCH21, and LCH31 latch the polarity signal POL on the basis of the gate selection signals G1, G2, and G3. In addition, the polarity signal POL that is inverted is latched to the first latch circuit LCH21 corresponding to an even-numbered line. This is to make line inversion possible by causing the electric potentials of the storage capacitance lines corresponding to odd-numbered lines (first line, third line, . . . ) and even-numbered lines (second line, fourth line, . . . ) to have opposite polarities. For example, the electric potential of the first storage capacitance line SC1 and the electric potential of the second storage capacitance line SC2 have opposite polarities.

In addition, second latch circuits LCH12, LCH22, and LCH32 are provided corresponding to the first to third storage capacitance lines SC1 to SC3, respectively. The second latch circuits LCH12, LCH22, and LCH32 latch the polarity signal POL latched by the first latch circuits LCH11, LCH21, and LCH31 on the basis of the first to third timing clocks TCLK1 to TCLK3, respectively. The first to third timing clocks TCLK1 to TCLK3 are pulse signals generated at different timing corresponding to each line. The first to third timing clocks TCLK1 to TCLK3 are generated on the basis of a timing signal TCLK by a timing control circuit 231.

First to third latch signals POL1 to POL3, which are output signals of the second latch circuits LCH12, LCH22, and LCH32, are used as signals for controlling switching of first to third switches SW1 to SW3 provided in a subsequent stage.

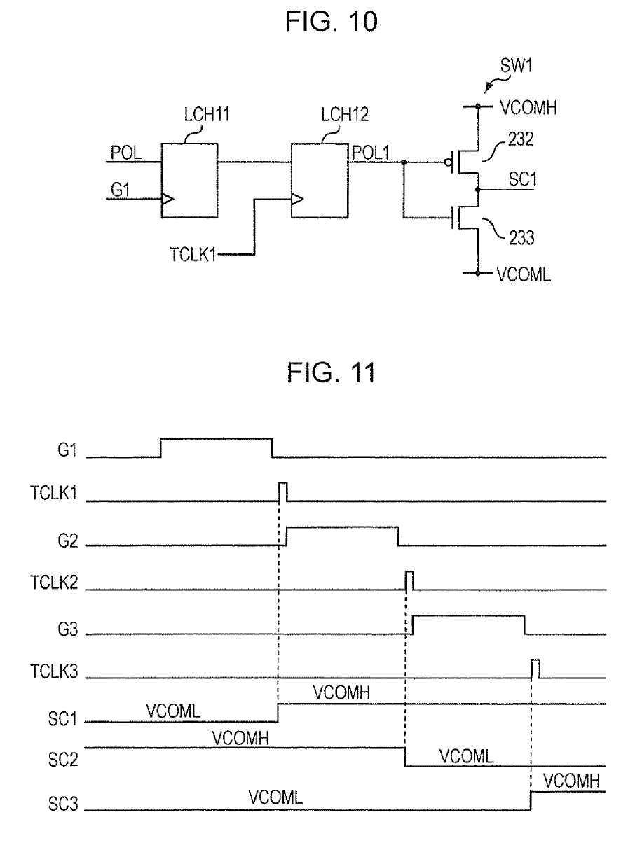

The configuration of the first switch SW1 is shown in FIG. 10. A P-channel TFT 232 and an N-channel TFT 233 are connected in series between the high electric potential VCOMH and the low electric potential VCONL, and the first latch signal POL1 output from the second latch circuit LCH12 is applied to gates of the TFTs 232 and 233. In addition, the second and third switches SW2 and SW3 have the same configuration.

For example, when the first latch signal POL1 is in an H level, the low electric potential VCOML is applied to the first storage capacitance line SC1 since the N-channel TFT 233 is turned on. In addition, when the first latch signal POL1 is in an L level, the high electric potential VCOMH is applied to the first storage capacitance line SC1 since the P-channel TFT 232 is turned on.

The electric potentials of the first to third storage capacitance lines SC1 to SC3 are determined by timing at which the first to third timing clocks TCLK1 to TCLK3 rise. In such a storage capacitance line driving method, it is general that such timing occurs after the gate selection signals G1 to G3 fall. FIG. 11 shows the relationship of changes of electric potentials of the gate selection signals G1 to G3, the first to third timing clocks TCLK1 to TCLK3, and the first to third storage capacitance lines SC1 to SC3.

### Configurations of Source Line Driving Circuit and DSG Control Circuit

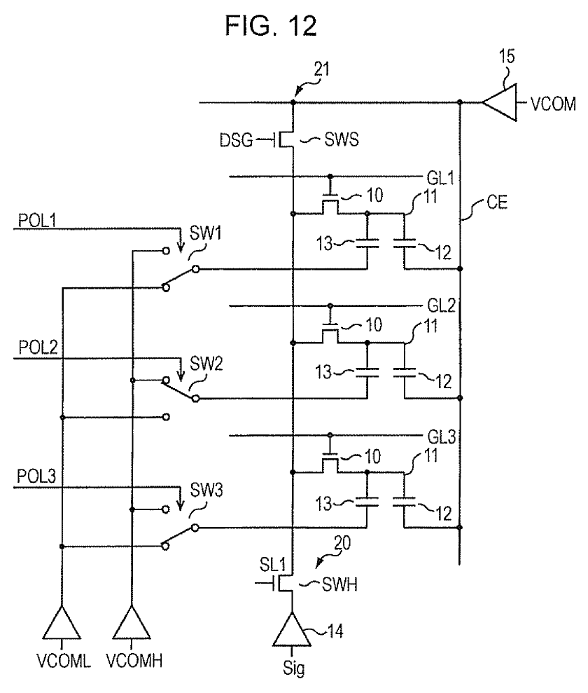

FIG. 12 is a view illustrating the configurations of the source line driving circuit 20 and DSG control circuit 21 which are provided in the periphery of the pixel region. In FIG. 12, only the configuration related to pixels corresponding to the first column of the pixel region is shown. An output terminal of a source driver 14 is connected to one end of the first source line SL1 with a horizontal switch SWH interposed therebetween. The horizontal switch SWH switches according to a horizontal scanning signal. When the horizontal switch SWH is turned on, the source signal Sig (display signal) is supplied from the source driver 14 to the first source line SL1.

In addition, an output terminal of a common electrode driver 15 is connected to the other end of the first source line SL1 with a switch SWS interposed therebetween. The switch SWS switches according to the control signal DSG. In addition, the output terminal of the common electrode driver 15 is connected to the common electrode CE, and the common electric potential VCOM is supplied to the common electrode CE. Accordingly, when the switch SWS is turned on, the first source line SL1 and the common electrode CE are short circuited, such that the common electric potential VCOM is also supplied to the first source line SL1 for precharge.

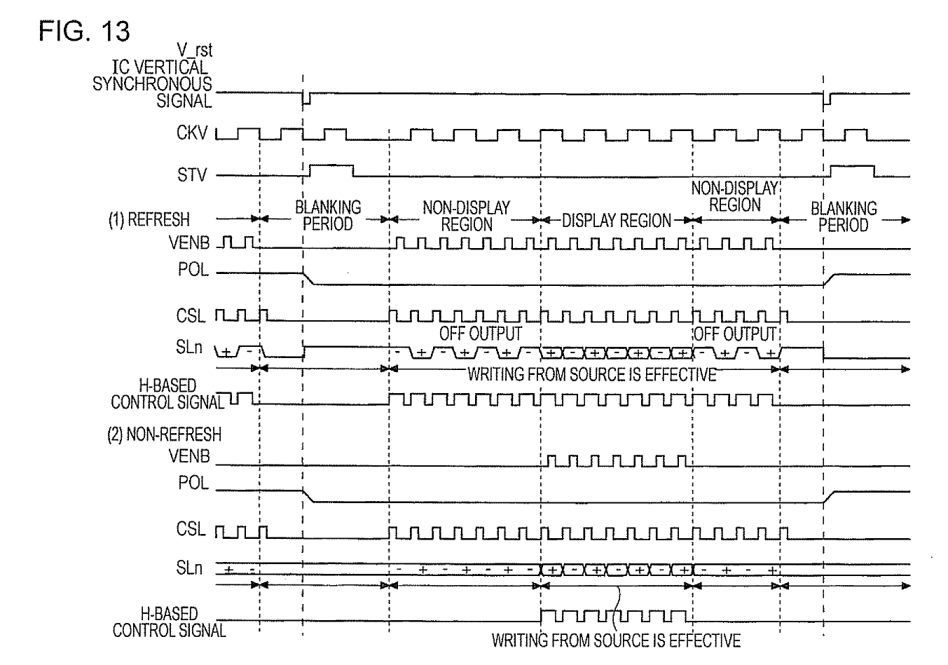

Next, an operation example of the liquid crystal display device will be described with reference to a timing chart shown in FIG. 13. Here, it is assumed that partial display is performed.

### (1) Refresh Operation

A refresh operation is performed in a non-display region. In this case, the gate selection enable signal VENB is periodically generated also in the non-display region so that the gate selection signals G1 to G3 are sequentially output to the first to third gate lines GL1 to GL3. Then, the source signal sig (non-display signal) corresponding to non-display is supplied to the first source lines SL1 to SL3 so as to be supplied to pixels, such that a refresh operation is performed. On the other hand, the gate selection enable signal VENB is periodically generated also in the display region so that the gate selection signals G1 to G3 are sequentially output to the first to third gate lines GL1 to GL3. Then, the source signal sig (display signal) corresponding to display is supplied to the first source lines SL1 to SL3 so as to be supplied to pixels, such that normal liquid crystal display is performed.

In addition, the storage capacitance line driving circuit 23 also operates. Accordingly, the electric potentials of the first to third storage capacitance lines SC1 to SC3 are repeatedly inverted in synchronization with the first to third latch signals POL1 to POL3. As a result, storage capacitance line driving is performed. That is, the display signal (non-display signal) is written into the pixel electrode and then the electric potential of the corresponding storage capacitance line is changed and accordingly, the electric potential of the pixel electrode 11 is changed in a positive or negative direction. Thus, since a dynamic range of the display signal can be made small, driving becomes possible with low power consumption.

### (2) Non-Refresh Operation

In the case of intermittent refresh, there is a frame in which a refresh operation is not performed. That is, refresh of a non-display region is not performed in a non-refresh frame. In this case, the first to third gate lines GL1 to GL3 are fixed to L levels by stopping the gate selection enable signal VENB (fixing the gate selection enable signal VENB to an L level). As a result, a non-display signal is not written into a pixel electrode.

Thus, in the case of the intermittent refresh, the refresh operation can be stopped by stopping the gate selection enable signal VENB. Therefore, it becomes an issue in which frame the refresh operation is to be performed. This will be described using a timing chart shown in FIG. 7.

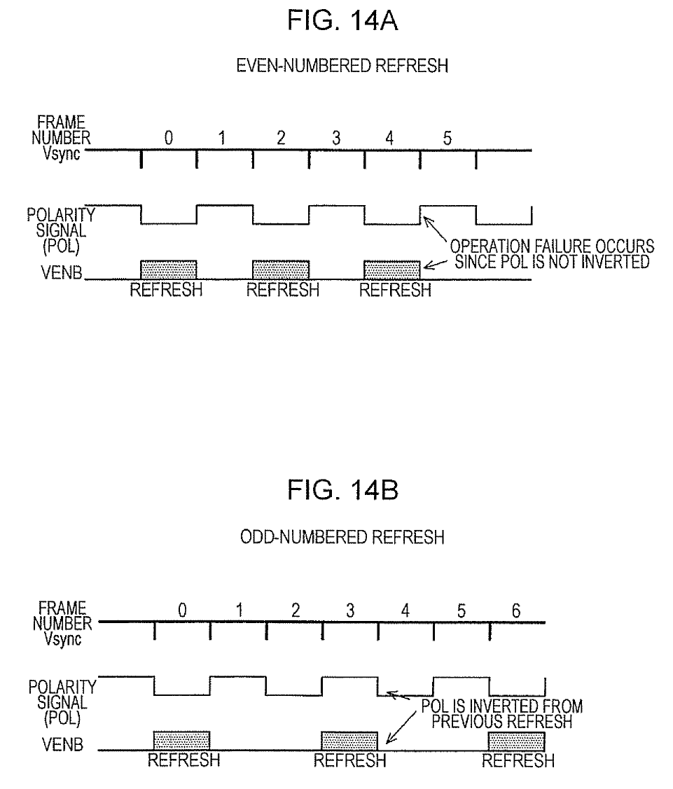

As shown in FIG. 14A, in the case of performing a refresh operation for every other frame in the intermittent refresh, the polarity signal POL is always in an L level and is not inverted to an H level in a frame in which a refresh operation is performed. Accordingly, since storage capacitance line driving is stopped (electric potentials of the first to third storage capacitance lines SC1 to SC3 are fixed), poor display occurs. In general, in the case of even number refresh in which a refresh operation is performed only in an even-numbered frame with a frame, in which the refresh operation has been performed, as a reference, the above problem occurs since the polarity of the polarity signal POL is equal.

Accordingly, as shown in FIG. 14B, when a refresh operation is performed for every two frames in the intermittent refresh, the polarity signal POL is inverted repeatedly for a frame in which the refresh operation is performed. That is, the refresh operation is performed in a 0-th frame, a third frame, a six frame, . . . , and the polarity signal POL is inverted to have an L level in the 0-th frame, an H level in the third frame, and an L level in the six frame. Such an operation may be realized by causing the control circuit 25 to make a control such that the gate selection enable signal VENB is activated in the above specific frames.

Thus, also in the refresh of the non-display region, the polarity signal POL is inverted in the same manner as in the display region and the storage capacitance line driving is performed. As a result, the poor display is prevented. In general, in the case of odd number refresh in which a refresh operation is performed only in an odd-numbered frame with a frame, in which the refresh operation has been performed, as a reference, the above problem can be solved since the polarity of the polarity signal POL is repeatedly inverted.

What is claimed is:

1. A liquid crystal display device comprising:
a pixel region including a plurality of pixels;
a plurality of storage capacitance lines;
a storage capacitor connected between a pixel electrode of each of the pixels and each of the storage capacitance lines;
a polarity signal generating circuit that generates a polarity signal, which is repeatedly inverted between a first level and a second level for every frame, in a display region of the pixel region where an image is displayed and that fixes the polarity signal to the first level or the second level in a non-display region where an image is not displayed;
a first switching element that switches an electric potential of the storage capacitance line according to the polarity signal generated by the polarity signal generating circuit; and
a control circuit that when the display region is changed to the non-display region, makes a control such that a refresh operation of writing a signal corresponding to non-display into the pixel electrode of the pixel corresponding to the non-display region is intermittently performed in some frames and the refresh operation is performed in two or more continuous frames.

2. The liquid crystal display device according to claim 1,
wherein the polarity signal generating circuit includes:
a frame inversion signal generating circuit that generates a frame inversion signal that is repeatedly inverted between the first level and the second level for every frame;
a memory in which data indicating distinction between the display region of the pixel region where an image is displayed and the non-display region where an image is not displayed is stored; and
a logic circuit that outputs the frame inversion signal as the polarity signal when the data output from the memory indicates the display region and outputs the polarity signal fixed to the first level or the second level when the data output from the memory indicates the non-display region.

3. The liquid crystal display device according to claim 2,
wherein the logic circuit is an AND circuit to which the data output from the memory and the frame inversion signal generated by the frame inversion signal generating circuit are applied.

4. The liquid crystal display device according to claim 1, further comprising:
a latch circuit that latches the polarity signal generated by the polarity signal generating circuit on the basis of a timing signal,
wherein the first switching element switches the electric potential of the storage capacitance line according to the polarity signal latched by the latch circuit.

5. The liquid crystal display device according to claim 1, further comprising:
a common electrode to which a common electric potential is applied;
liquid crystal disposed between the pixel electrode and the common electrode; and
a second switching element that applies the common electric potential to the pixel electrode of the pixel corresponding to the non-display region.

6. A driving method of a liquid crystal display device that includes a pixel region including a plurality of pixels, a plurality of storage capacitance lines, a storage capacitor connected between a pixel electrode of each of the pixels and each of the storage capacitance lines, a polarity signal generating circuit that generates a polarity signal, which is repeatedly inverted between a first level and a second level for every frame, in a display region of the pixel region where an image is displayed and that fixes the polarity signal to the first level or the second level in a non-display region where an image is not displayed, and a first switching element that switches an electric potential of the storage capacitance line according to the polarity signal generated by the polarity signal generating circuit, comprising:
intermittently performing a refresh operation of writing a signal corresponding to non-display into the pixel electrode of the pixel corresponding to the non-display region in some frames and performing the refresh operation in two or more continuous frames when the display region is changed to the non-display region.

7. A liquid crystal display device comprising:
a pixel region including a plurality of pixels;
a plurality of source lines;
a plurality of gate lines;
a plurality of storage capacitance lines;
a storage capacitor connected between a pixel electrode of each of the pixels and each of the storage capacitance lines;
a gate selection circuit that outputs a gate selection signal to the gate lines;
a first latch circuit that latches a polarity signal, which repeats inversion alternately between a first level and a second level for every frame, according to the gate selection signal;
a first switching element that switches an electric potential of the storage capacitance line according to an output signal of the first latch circuit; and
a second switching element that is provided for every pixel, switches according to the gate selection signal, and supplies a source signal from the source line to the pixel electrode,
wherein in a non-display region of the pixel region where an image is not displayed, a control is made such that a refresh operation of supplying a source signal corresponding to non-display to the corresponding pixel through the first switching element is performed in remaining frames after thinning out two or more frames and a polarity signal is inverted in a first frame in which a refresh operation is performed and a second frame in which a next refresh operation is performed.

8. The liquid crystal display device according to claim 7,
wherein in a display region where the image is displayed, a control is made such that the source signal is supplied to the corresponding pixel through the second switching element and a polarity signal, which is an output signal of the first latch circuit, is inverted for every frame.

9. The liquid crystal display device according to claim 7,
wherein the gate selection circuit includes a control circuit that controls a gate selection enable signal such that the gate selection signal is output on the basis of the gate selection enable signal.

10. The liquid crystal display device according to claim 7, further comprising:
a second latch circuit that latches an output signal of the first latch circuit according to a timing signal,
wherein the first switching element switches the electric potential of the storage capacitance line according to an output signal of the second latch circuit.

11. A driving method of a liquid crystal display device that includes a pixel region including a plurality of pixels, a plurality of source lines, a plurality of gate lines, a plurality of storage capacitance lines, a storage capacitor connected between a pixel electrode of each of the pixels and each of the storage capacitance lines, a gate selection circuit that outputs a gate selection signal to the gate lines, a first latch circuit that latches a polarity signal, which repeats inversion alternately between a first level and a second level for every frame, according to the gate selection signal, a first switching element that switches an electric potential of the storage capacitance line according to an output signal of the first latch circuit, and a second switching element that is provided for every pixel, switches according to the gate selection signal, and supplies a source signal from the source line to the pixel electrode, comprising:
making a control such that in a non-display region of the pixel region where an image is not displayed, a refresh operation of supplying a source signal corresponding to non-display to the corresponding pixel through the first switching element is performed in remaining frames after thinning out two or more frames and a polarity signal is inverted in a first frame in which a refresh operation is performed and a second frame in which a next refresh operation is performed.

12. The driving method of a liquid crystal display device according to claim 11,
wherein the gate selection circuit outputs the gate selection signal on the basis of a gate selection enable signal and controls the gate selection enable signal such that the polarity signal is inverted in the first frame in which a refresh operation is performed and the second frame in which a next refresh operation is performed.
